(19) United States
(12) Patent Application Publication
(10) Pub. No.: US 2014/0213222 A1
(43) Pub. Date: Jul. 31, 2014

(54) Automated call and SMS greetings.

(71) Applicant: Rollan Roberts, II, Whitefish, MT (US)

(72) Inventor: Rollan Roberts, II, Whitefish, MT (US)

(21) Appl. No.: 14/071,072

(22) Filed: Mar. 7, 2014

Related U.S. Application Data
(60) Provisional application No. 61/724,670, filed on Nov. 9, 2012.

(51) Int. Cl. H04W 4/14

(52) U.S. Cl. CPC H04W 4/14
USPC 455/412.1

(57) ABSTRACT

Automated call and SMS greetings is disclosed. This integration of technology, combining online social software with phone, SMS, and the individual's voice, introduces a new combination of how technology and industries (greeting card and social media) integrates to provide a fun, positive consumer experience. This proprietary social media/technology integration process significantly expands the reach of social media by integrating additional technologies for the purpose of communicating in another dimension. The key distinction with this protocol is that it integrates with social networks to suggest sending a call or SMS based on various emotions in posts and status updates. If an individual puts a frown face or says they've had the worst day, the technology can pop up asking if they'd like to choose a greeting to send to them via call or SMS.

### BACKGROUND OF THE INVENTION

### Problem Solved

Greeting cards take too long to get to people. Mailing birthday or holiday cards can get there late. People want to act on their intuition but a card that takes days to get there is cumbersome or even inappropriate. Furthermore, social networks only have the functionality that allows a person to respond to a post, status update, picture, video or other media by replying with comments. This invention allows social networks to integrate this solution into their platform to respond to mood, keywords, phrases, emotions and the like by prompting users and friends of users to select an appropriate greeting to send via phone call or SMS as opposed to simply replying to a comment. This also adds an added layer of consumer privacy for individuals on social networks.

Greeting, birthday, and holiday cards take too long to get to recipients using the postal system. Most of today's generation doesn't either the postal system or greeting cards. Social media, such as Facebook and Twitter, have not been able to go beyond the comment box allowing others to communicate socially with various technologies specifically based on mood, thoughts, feelings, and emotions users have shared on social networks.

This integration of technology, combining online social network platforms with phone, SMS, and the individual's unique voice, introduces a new combination of how technology and industries (greeting card and social media) integrates to provide a fun, positive consumer experience. This proprietary social media/technology integration process significantly expands the reach of social media by integrating additional voice and data technologies for the purpose of communicating through other platforms without leaving the social network.

This patent claims the programming and function of sending automated calls and SMS messages through social media applications.

### DETAILED DESCRIPTION OF THE INVENTION

As stated above, greeting cards take too long to get to people. Mailing birthday or holiday cards can get there late. People want to act on their intuition but a card that takes days to get there is cumbersome or even inappropriate. Most posts on social networks do not initiate a greeting card by friends and family and comments are not as meaningful as a phone call or greeting card. The invention claimed here solves this problem.

The automated call and/or SMS greetings allow automated or custom-recorded messages to be immediately sent through mobile apps, online, or social networks. Individuals can share how thankful they are for a colleague, or their love for a spouse, or wish a happy birthday or merry Christmas immediately in a fun, social manner. It solves the need for immediacy and minimizes the need for emotional delayed gratification when sharing greeting sentiments. It adds context, meaning and a personal touch significantly beyond replying to a social network post or comment.

The claimed invention differs from what currently exists. It is different from anything in the social media industry in that it transitions from just online interaction to integrating with other communication methods such as the phone and text messaging to express mood, emotions and sentiments. The uniqueness lies in that its an online or mobile social tool that uses offline technologies (phone and SMS) to deliver pre-recorded or custom-recorded messages independently or as a response to social network posts and status updates.

This invention is an improvement on what currently exists. It is different from anything in the social media industry in that it transitions from just online interaction to integrating with other communication methods such as the phone and text messaging to express mood, emotions and sentiments. The uniqueness lies in that it's an online or mobile social tool that uses offline technologies (phone and SMS) to deliver pre-recorded or custom-recorded messages independently or as a response to social network posts and status updates.

No social media invokes the emotion that the traditional greeting card historically has (and the e-card industry never has!). Traditional social media does not attempt to use other technologies to enrich the thorough human communication experience. This protocol monitors social networks and then pro-actively recommends a specific greeting be sent as a result of mood, keywords or emotions (i.e. frown face, smiley face).

This integration of technology, combining online social platforms with phone, SMS, and the individual's voice, introduces a new combination of how technology and industries (greeting card and social media) integrates to provide a fun, positive consumer experience. This proprietary social media/technology integration process significantly expands the reach of social media by integrating additional technologies for the purpose of communicating in another dimension.

### The Version of the Invention Discussed here Includes

This system can be used independently on a mobile app or online on the website. A further unique and powerful use is integrating it with social network platforms that monitors social network posts, comments, status updates, and all forms of media and then pro-actively recommends a specific greeting be sent as a result of mood, keywords or emotions (i.e. frown face, smiley face).
1. User enters the phone number they wish to call or text (can be integrated with their contacts, friends, or other forms of contact management)
2. Users select which pre-recorded greeting they would like to send from a number of categories or record their own custom greeting
3. Users select if they would like the pre-recorded message shared in a male or female voice
4. Users enter the name of the person sending the message (who the message is from)
5. Users choose when they want to send the message
6. Users can choose to listen to the greeting they have selected
7. Users then click the “send” button to send the message immediately or to be delivered at the scheduled time

### Relationship Between the Components

1. Users go online or utilize a mobile app or mobile website to enter in the phone number of the person they wish to send a call or SMS to. If SMS is selected, an if-then statement does not ask the user if they want the message delivered in a male or female voice. This data, along with the data captured in steps 2 (which message they want to send) and 3 (which voice to send it in) along with who the message is from and when they want the recipient to receive the message is all captured through software code that is integrated with a third party voice and messaging cloud software provider. A chron job initiates the protocol the end user has submitted to complete the call or SMS. 2. A database houses all of the pre-recorded male and female voice messages that users select from. After the call or SMS is sent, users are directed to a Thank You page that has the user already signed in to Facebook (if they are logged in on the device or computer) where they are encouraged to submit their experience via social media. This entire user experience can also occur within the social networks themselves.

### How the Invention Works

The software code and database capture all necessary data, house pre-recorded messages and SMS messages along with any custom messages that get recorded. Based on that data and the selections of the user during the aforementioned steps, the appropriate protocol is sent via the integration to a hosted voice and SMS application that then carries out the requested action. If a message is scheduled to be sent at a later time other than now, that directive is held and sent to the host voice/SMS application at the appropriate time. Then comes the Facebook integration where users can share their experience with their friends and circles of influence. It connects the offline social (greeting cards and telephone) outlets with the online social media world (Facebook and other integrations). Integrations with social media sites allow users to send messages based on mood, emotions and status updates posted on those sites.

If a user selects SMS in step 1, there is an if-then statement that eliminates the need for the user to select if they want the message sent in a male or female voice. In addition, there is a scheduler that allows calls to be sent immediately if it is between appropriate FTC call times or they can select to send the message in the morning, afternoon, or evening. The scheduler as a series of if-then statements based on which time the call has been scheduled for.

### How to Make the Invention

A person would need to write the code to capture the required elements and then sort out what to do what that data. This includes writing programs that trigger when to release certain data sets to the voice/SMS application. Then, a programmer would need to find a voice and data provider that they could integrate with their software. The two would need to talk so that numerous variations of messages, voice types, SMS, and calls could be accurately sent to the correct phone numbers. A front end website portal would need to be built to display these options for the general public. Online social media integration would then be added to a Thank You page after a call or SMS has been sent.

All of these elements are necessary except for the Facebook and social media integration after a message has been sent—that is optional. Because this technology process is a unique way of letting people communicate mood, feelings and emotions with one another, it is social media. These steps are necessary and required for the functioning of this integration of technology: A person would need to write the code to capture the required elements and then sort out what to do what that data. This includes writing programs that trigger when to release certain data sets to the voice/SMS application. Then, a programmer would need to find a voice and data provider that they could integrate with their software. The two would need to talk so that numerous variations of messages, voice types, SMS, and calls could be accurately sent to the correct phone numbers. A front end website portal would need to be built to display these options for the general public.

This combination of technology protocol could read social media statuses, posts, and updates from sites like Facebook, Google Plus, and Twitter, and then prompt users to send a message to someone based on the emotion of the user or recipient. If a Facebook post said, “My day sucked”, then a user of this technology may have an option appear that lets them record an uplifting message or they can send a pre-recorded message about how thankful they are for them.

### How to Use the Invention

A person would use this technology process to immediately share mood, thoughts, feelings, and emotions they have toward someone. Instead of mailing a thank you, love, birthday, holiday, or greeting card or sending an e-card to someone who never checks their email, users are able to instantly send a call or SMS that allows them to express their mood and emotions in a social way. Because it combines several technologies (phone, SMS, online/mobile), this process becomes an experience that people appreciate more than simply receiving a text message or phone call with the same content. It's the manner in which the message is communicated that makes it special. It solves the problem of speed because calls and SMS messages can be sent immediately, but it still shows that thought and care went into sharing the emotion. It's also an advanced form of sharing the emotion through a Facebook, Twitter, or Google Plus status update or post. It personalizes it in a special, fun and unique way.

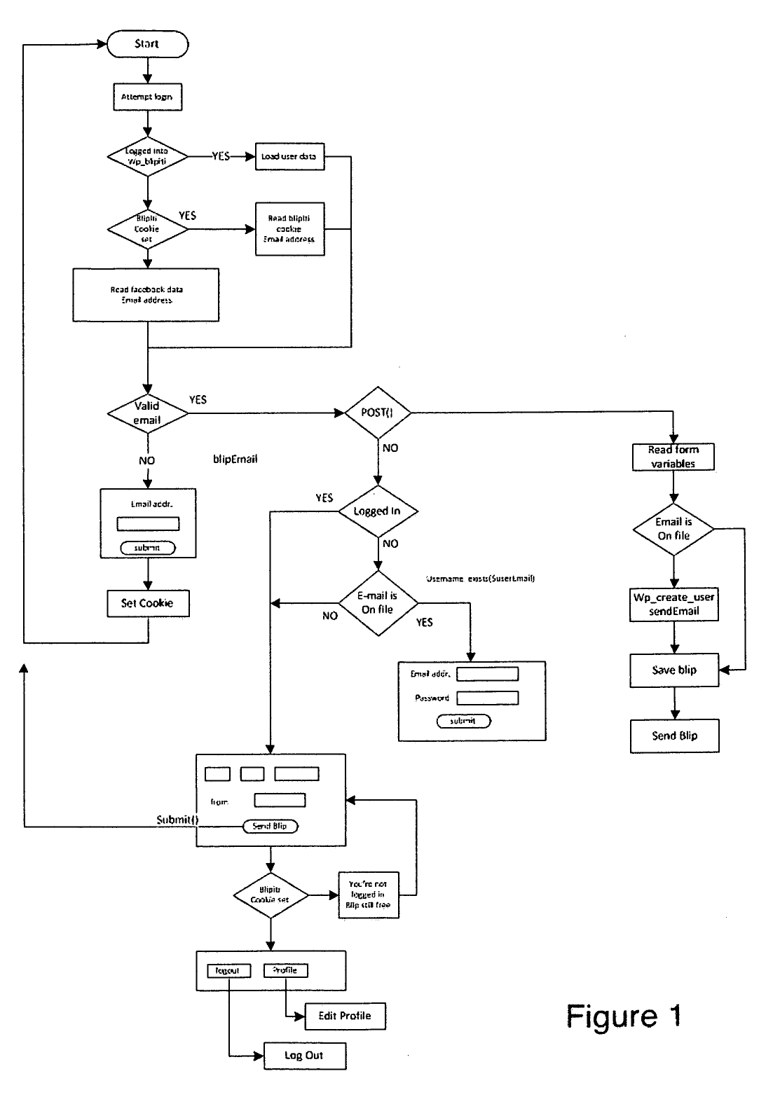

### FIG. 1 DESCRIPTION

FIG. 1 drawing contains the programming logic and flow for how users use the Automated Call and SMS Greetings application. It contains the if/then logic from the moment a user attempts to log into the application and throughout the entire application experience until they log out.

1. This patent claims the programming and function of sending automated calls and SMS messages through the web, app and social media applications specifically limited to the process and flow contained as follows:
We claim the process of going to a web page, social media platform or app, choosing whether to send a pre-recorded or custom message in a male or female voice, choosing whether to send that pre-recorded or custom message through SMS text or phone call, choosing the pre-recorded or message to be sent, inputting the number it should go to, inputting the sender's name, and scheduling the call or SMS message to be sent based on outbound call hours as outlined by the states, FTC, and FCC.
The claim is specific to pre-recorded and custom messages that express mood, emotions or sentiments. Examples would be topics similar to what can be found on greeting cards: birthday, holiday, gratitude, thanks, and love.
The claim does not include robo-dialing or the general automation of outbound phone calls or SMS texts.
